(19) United States
(12) Patent Application Publication
(10) Pub. No.: US 2016/0298733 A1
(43) Pub. Date: Oct. 13, 2016

(54) Dual Clutch Transmission

(71) Applicant: DAIMLER AG, Stuttgart (DE)

(72) Inventors: Helmut BENDER, Pleidelsheim (DE); Josep Maria BOU ROMANO, Stuttgart (DE); Heinrich STRAUB, Stuttgart (DE); Peter HAHN, Stuttgart (DE); Stefan SPERRFECHTER, Donzdorf (DE); Juergen SCHWEITZER, Filderstadt (DE); Tobias HAERTER, Stuttgart (DE); Jakub ROMANIAK, Stuttgart (DE)

(73) Assignee: Daimler AG, Stuttgart (DE)

(21) Appl. No.: 15/036,754

(22) PCT Filed: Nov. 4, 2014
(86) PCT No.: PCT/EP2014/002954

§ 371 Date: May 13, 2016

(30) Foreign Application Priority Data
Nov. 15, 2013 (DE) 10 2013 019 121.1

(51) Int. Cl. F16H 3/093; F16H 3/00

(52) U.S. Cl. CPC F16H 3/093; F16H 3/006; F16H 2003/0931; F16H 2200/006; F16H 2200/0065; F16H 2200/0086

(57) ABSTRACT

The invention relates to a dual clutch transmission comprising two input shafts (11a, 12a; 11b, 12b) which are provided for respectively linking to a power shift clutch (K1a, K2a; K1b, K2b), a first countershaft (13a; 13b) arranged offset parallel to the input shafts (11a, 12a; 11b, 12b), a second countershaft (14a; 14b) arranged offset parallel to the input shafts (11a, 12a; 11b, 12b), at least five gear wheel planes (Z1a-Z5a; Z1b-Z5b) which each comprise a fixed gear (Z11a-Z51a; Z11b-Z51b) permanently connected in a rotationally fixed manner to one of the input shafts (11a, 12a; 11b, 12b), wherein one of the gear wheel planes (Z4a; Z4b) comprises an idler gear wheel (Z42a; Z42b) arranged coaxially relative to the first countershaft (13a; 13b) and an idler gear wheel (Z43a; Z43b) arranged coaxially relative to the second countershaft (14a; 14b), which form a gear wheel pair for shifting into at least one reverse transmission gear (R1a, R2a), at least nine shift units (S1a-S9a; S1b-S9b) for producing an operative connection between the input shafts (11a, 12a; 11b, 12b) and/or the countershafts (13a, 14a; 13b, 14b), which in connection with the gear wheel planes (Z1a-Z5a; Z1b-Z5b) are provided at least constructively for shifting of at least eight sequentially shiftable forward transmission gears (V1a-V8a) and the at least one reverse transmission gear (R1a, R2a), an output (Z01a; Z01b) permanently connected in a rotationally fixed manner to the first countershaft (13a; 13b), and an output gear wheel (Z02a; Z02b) permanently connected to in a rotationally fixed manner to the second countershaft (14a; 14b).

The invention relates to a dual clutch transmission for a drive train of a motor vehicle.

A dual clutch transmission is already known from DE 10 2009 002 353 A1, comprising two input shafts which are provided for respectively linking to a power shift clutch, a first countershaft arranged offset parallel to the input shafts, a second countershaft arranged offset parallel to the input shafts, at least five gear wheel planes, and nine shift units.

The object of the invention is in particular to provide a compact dual clutch transmission with a high degree of flexibility. This object is achieved according to the invention by a dual clutch transmission having the features of claim 1, and by a dual clutch transmission having the features of claim 12. Further embodiments are disclosed by the subordinate claims.

According to the invention a dual clutch transmission is proposed, comprising two input shafts which are provided for respectively linking to a power shift clutch, a first countershaft arranged offset parallel to the input shafts, a second countershaft arranged offset parallel to the input shafts, at least five gear wheel planes which each comprise a fixed gear permanently connected in a rotationally fixed manner to one of the input shafts, wherein one of the gear wheel planes comprises an idler gear arranged coaxially relative to the first countershaft and an idler gear arranged coaxially relative to the second countershaft, which form a gear wheel pair for shifting into at least one reverse transmission gear, at least nine shift units for producing an operative connection between the input shafts and/or the countershafts, which in connection with the gear wheel planes are provided at least constructively for shifting of at least eight sequentially shiftable forward transmission gears and the at least one reverse transmission gear, an output gear permanently connected in a rotationally fixed manner to the first countershaft, and an output gear permanently connected in a rotationally fixed manner to the second countershaft.

Furthermore, according to the invention a dual clutch transmission is proposed, comprising two input shafts which are provided for respectively linking to a power shift clutch, a first countershaft arranged offset parallel to the input shafts, a second countershaft arranged offset parallel to the input shafts, at least five gear wheel planes which each comprise a fixed gear permanently connected in a rotationally-fixed manner to one of the input shafts, wherein one of the gear wheel planes comprises an idler gear arranged coaxially relative to the first countershaft and an idler gear arranged coaxially relative to the second countershaft, which form a gear wheel pair for shifting into at least one reverse transmission gear, an output gear arranged coaxially relative to the first countershaft, an output gear permanently connected in a rotationally fixed manner to the second countershaft, at least eight shift units for producing an operative connection between the input shafts and/or the countershafts and at least one shift unit for producing an operative connection between the output gear arranged coaxially relative to the first countershaft and the second countershaft, wherein in connection with the gear wheel planes the at least nine shift units are provided at least constructively for shifting of the at least eight sequentially shiftable forward transmission gears and the at least one reverse transmission gear.

The dual clutch transmission is advantageously formed as a countershaft transmission and comprises a main axis of rotation and two auxiliary axes of rotation. In this case a “main axis of rotation” should be understood in particular to be an axis of rotation defined by the input shafts. An “auxiliary axis of rotation” should be understood in particular to be an axis of rotation arranged offset parallel to the main axis of rotation and defined by a countershaft.

Furthermore, a “shift unit” should be understood in particular to be a unit with precisely two coupling elements, which is provided for connecting two transmission elements which are rotatable relative to one another, such as for example an idler gear and a countershaft or adjacent idler gears of different gear wheel planes, shiftably to one another in a rotationally fixed manner. In this case two adjacent shift units can in principle be combined to form a common dual shift unit, for example by providing a common coupling element for both shift units. Each of the shift units can in principle be designed as a purely positively engaged shift unit, for example as a claw clutch, as a positively and frictionally engaged shift unit, for example in the form of a synchronized claw clutch, or as a purely frictionally engaged shift unit, for example in the form of a multiple-disc clutch.

Furthermore, a “gear wheel plane” should be understood in particular to be a transmission plane which has at least one gear wheel pair with at least two inter-engaging gear wheels which are provided in at least one of the transmission gears for transmission of a power flow. Within a gear wheel plane all the gear wheels are in each case operatively connected to one another in pairs. For example, a plurality of gear wheel pairs can form one single gear wheel plane when the different gear wheel pairs have at least one common fixed gear or at least one common idler gear. In this case in particular the idler gears can have a dual toothing.

An “output gear wheel plane” should be understood in particular to be an additional gear wheel plane, by means of which in all the transmission gears a power flow is led out of the dual clutch transmission. In this case a “fixed gear” should be understood to be a gear wheel of a gear wheel plane, which gear wheel is permanently connected in a non-rotatable manner to one of the input shafts or to one of the countershafts on which at least one idler gear is arranged. An “idler gear” should in particular be understood to be an individual gear wheel of a gear wheel plane, which gear wheel is arranged rotatably on a shaft and is merely permanently connected in a rotationally fixed manner to at least one coupling element of a shift unit. A “winding stage” should in particular be understood to be a coupling of two idler gears or fixed gears which in at least one transmission gear designed as a winding gear is provided in order to transmit a power flow between the two idler or fixed gears of different gear wheel planes. In this case, one of the shift units, one of the input shafts, one of the countershafts or an intermediate shaft is preferably provided for coupling of the idler gears or fixed gears. Furthermore, a “winding gear” should in particular understood to be a transmission gear which is formed by at least one winding stage.

“Provided constructively for shifting of transmission gears” should in particular be understood to mean that in principle a corresponding transmission gear can be formed mechanically, regardless of whether or not the shifting of the transmission gear is dispensed with in the context of a shifting strategy. “Provided” should be understood in particular to mean specially formed, designed, equipped and/or arranged.

The numbering of the gear wheel planes used in the description of the drawings and/or in the claims serves in particular for distinguishing the gear wheel planes. In particular, the numbering does not correspond to an arrangement in which the gear wheel planes are arranged one behind the other along the main extension direction. Analogously, the numbering of the shift units used in the description of the drawings and/or in the claims serves in particular for distinguishing the shift units. In particular, the numbering does not correspond to an arrangement in which the shift units are arranged one behind the other along the main extension direction. Thus the terms “first,” “second,” etc. in particular do not represent a succession, for example with regard to an arrangement, a flux of force, a drive or the like.

In principle a kinematically equivalent exemplary embodiment can be implemented by the following measures:
interchanging an arrangement of the gear wheel planes and/or the shift units, in particular by interchanging gear wheel planes of which the fixed or idler gear is arranged on the same input shaft and/or with which a dual shift unit is associated;
interchanging the take-off shafts or interchanged countershafts;
interchanging partial transmissions, wherein a partial transmission only has gear wheel planes of which the fixed or idler gears are linked to the same input shaft;
separating double gear wheel planes into two single gear wheel planes;
changing an arrangement of a parking brake wheel;
rotatable arrangement of a take-off gear wheel on a countershaft.

Further advantages can be seen from the following descriptions of the drawings. Five exemplary embodiments of the invention are illustrated in the drawings. The drawings, the description of the drawings, and the claims contain numerous features in combination. Expediently, a person skilled in the art will also consider the features singly and combine them to form further meaningful combinations.

In the drawings:

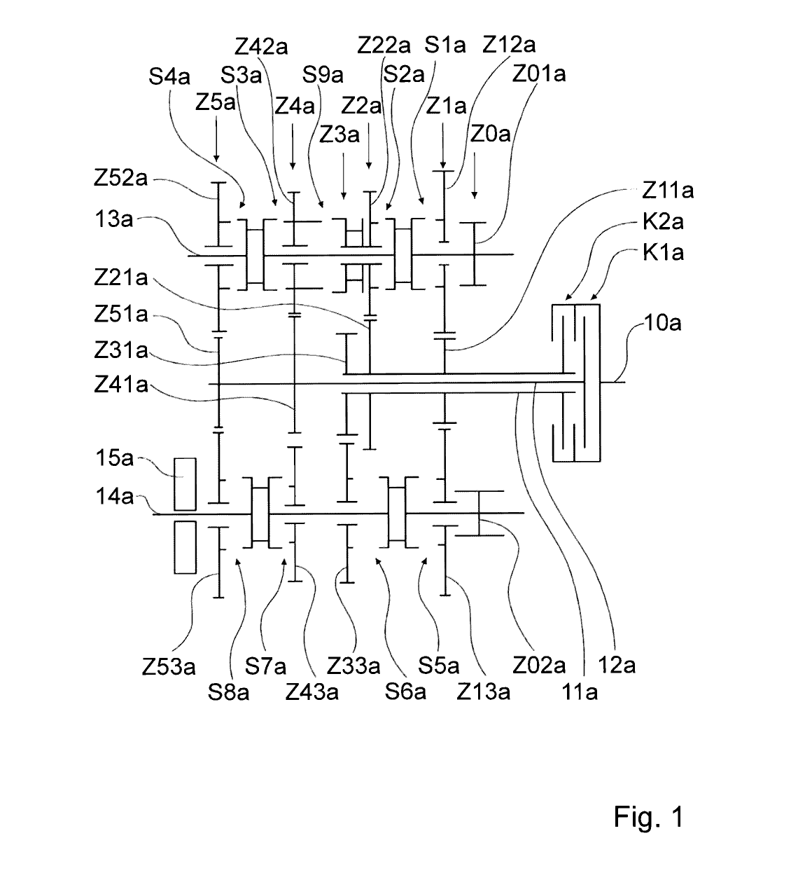

FIG. 1 a first transmission diagram of a dual clutch transmission according to the invention for a motor vehicle, with two output gears permanently connected in a rotationally fixed manner,

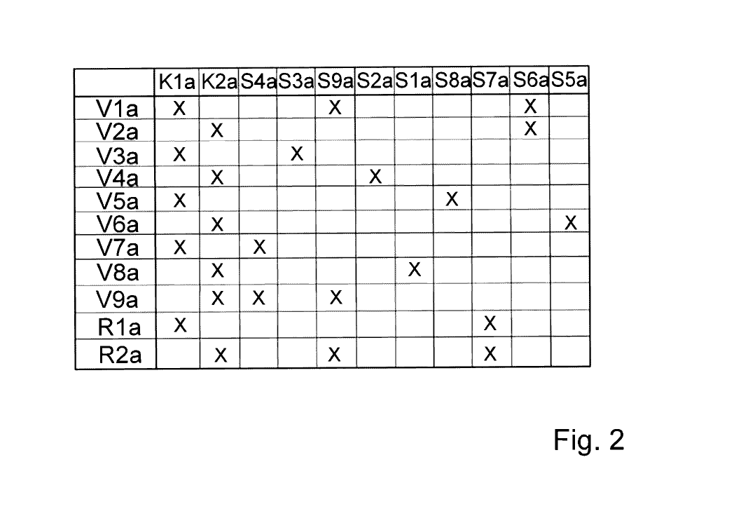

FIG. 2 a shift diagram of the dual clutch transmission according to FIG. 1,

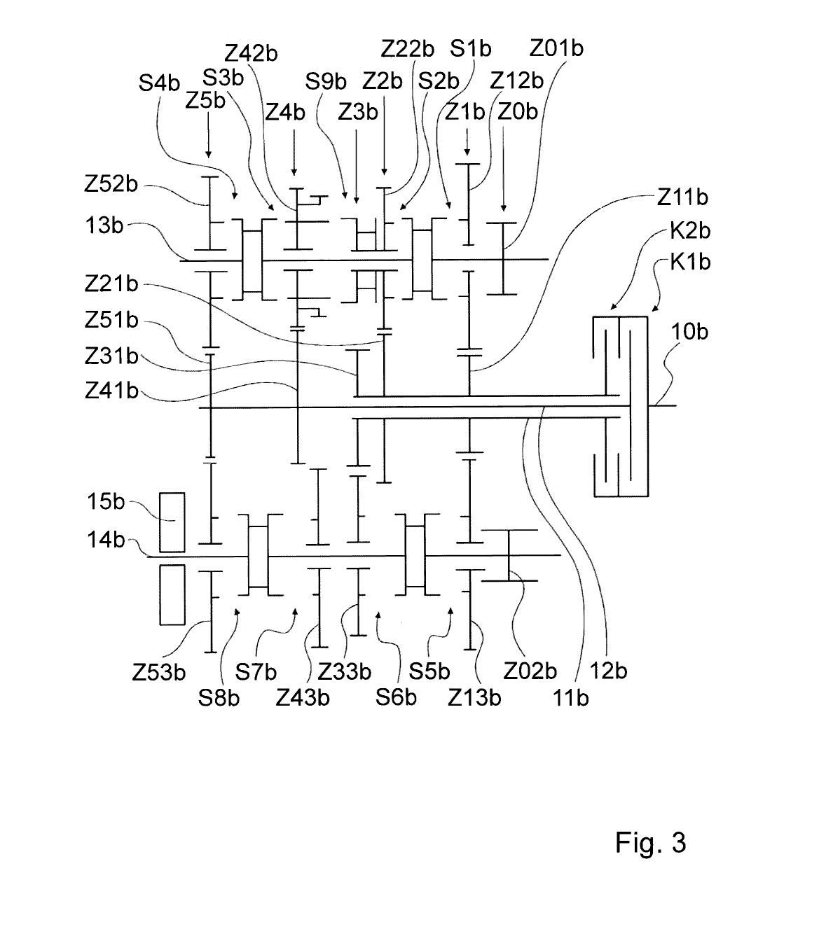

FIG. 3 a second transmission diagram of a dual clutch transmission according to the invention for a motor vehicle, with two output gears permanently connected in a rotationally fixed manner,

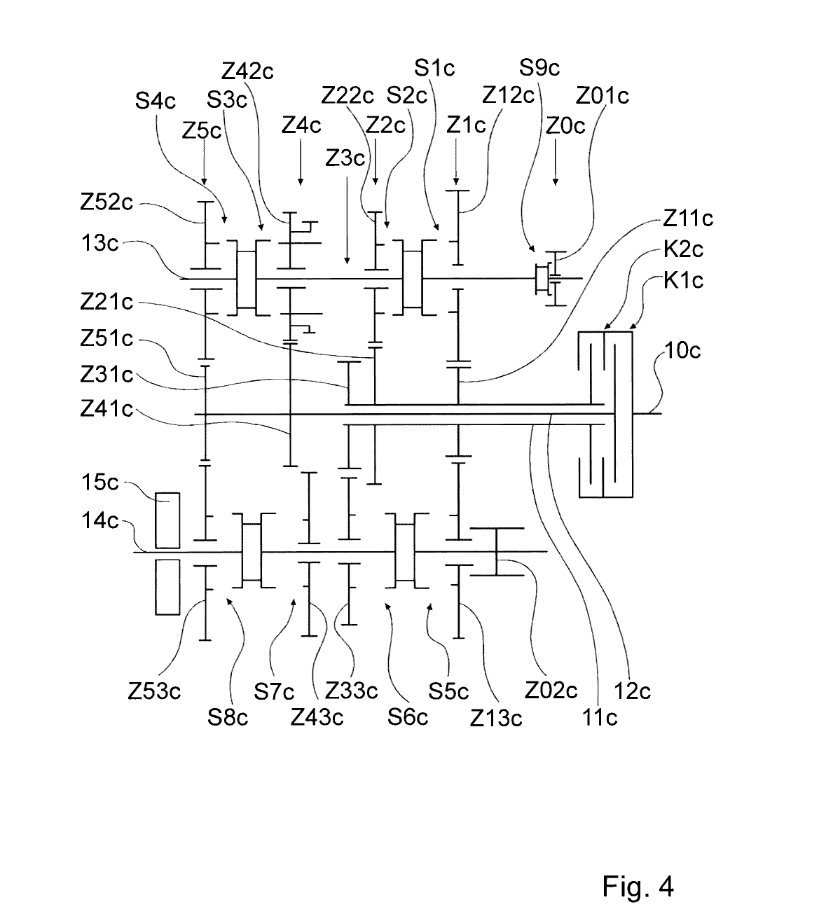

FIG. 4 a third transmission diagram of a dual clutch transmission according to the invention for a motor vehicle, with only one output gear permanently connected in a rotationally fixed manner,

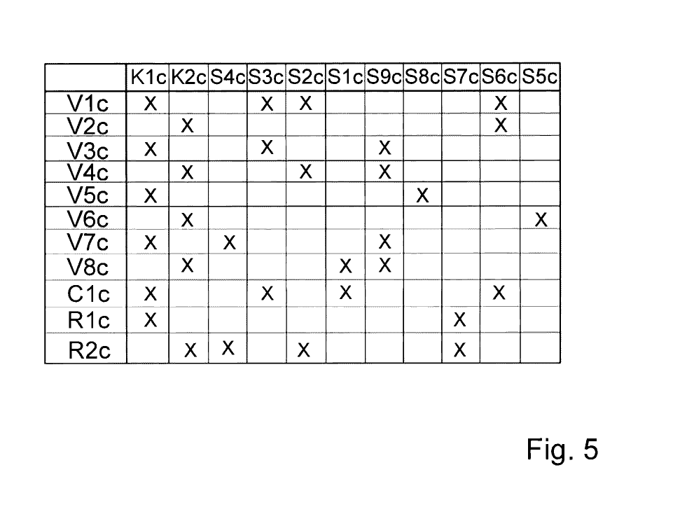

FIG. 5 a shift diagram of the dual clutch transmission according to FIG. 4,

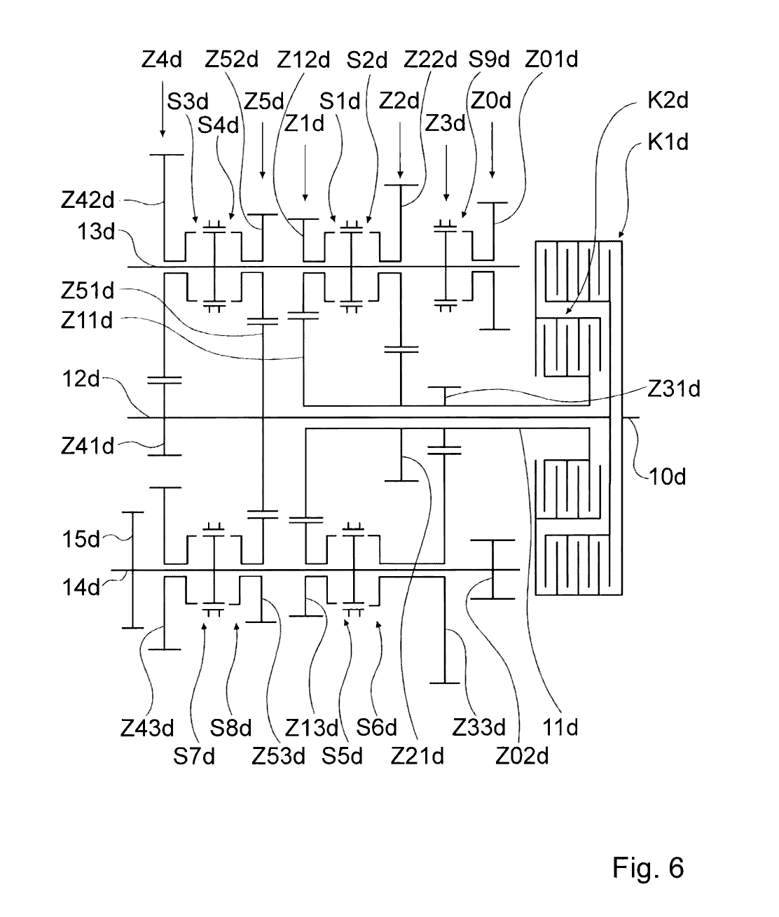

FIG. 6 a fourth transmission diagram of a dual clutch transmission according to the invention for a motor vehicle, with only one output gear permanently connected in a rotationally fixed manner,

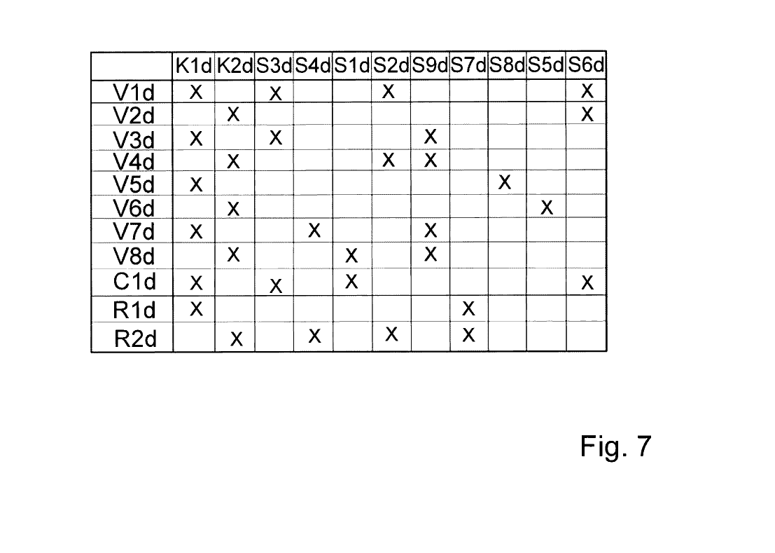

FIG. 7 a shift diagram of the dual clutch transmission according to FIG. 6,

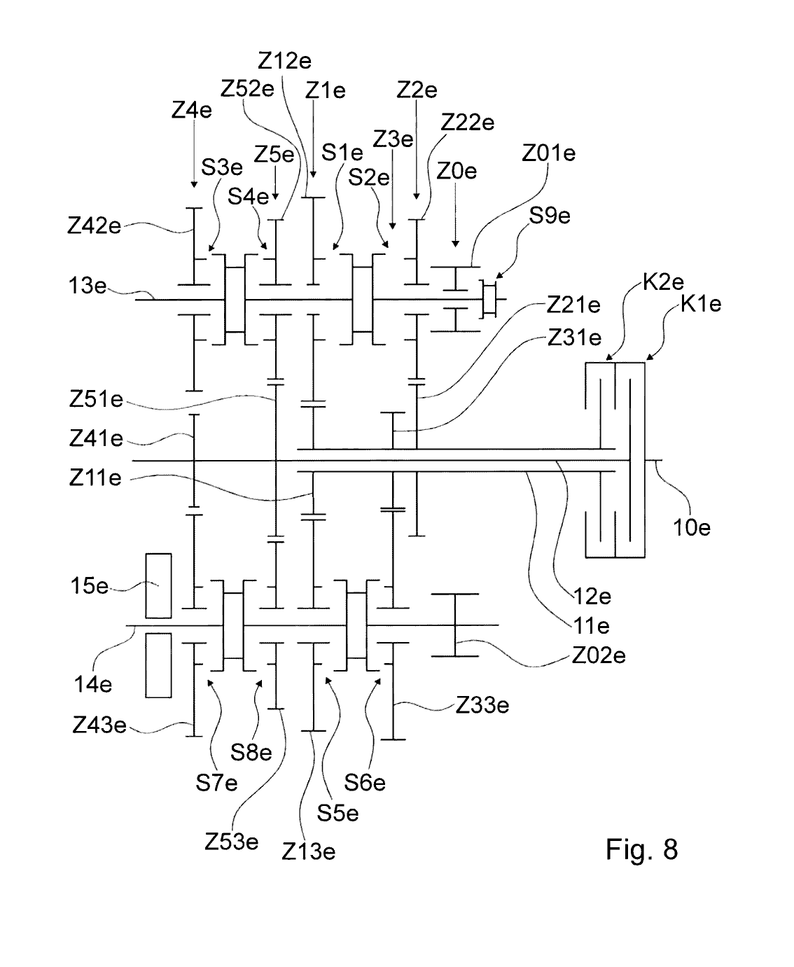

FIG. 8 a fifth transmission diagram of a dual clutch transmission according to the invention for a motor vehicle, with only one output gear permanently connected in a rotationally fixed manner, and

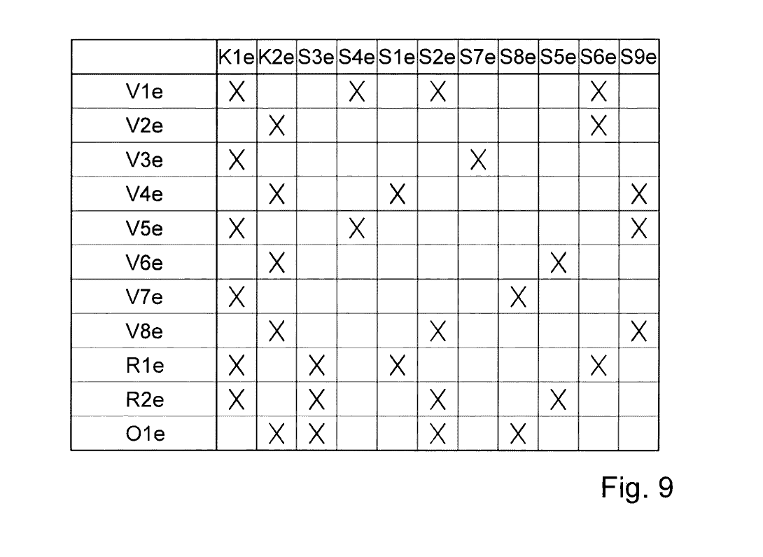

FIG. 9 a shift diagram of the dual clutch transmission according to FIG. 8.

FIG. 1 shows a transmission diagram of a dual clutch transmission of a motor vehicle. The dual clutch transmission is provided for front transverse mounting, i.e. for a motor vehicle which has a drive motor arranged transversely to the direction of travel disposed and a driven front axle. The dual clutch transmission comprises a drive shaft 10a which is provided for linking in a rotationally fixed manner to the drive motor. Furthermore, the dual clutch transmission comprises an input clutch which comprises two power shift clutches K1a, K2a arranged parallel in the flux of force. Moreover, the dual clutch transmission comprises an output gear wheel (not illustrated in greater detail) which is provided for linking to an axle drive (not illustrated in greater detail) for drive gears of the motor vehicle. The dual clutch transmission is provided for shifting of nine forward transmission gears V1a, V2a, V3a, V4a, V5a, V6a, V7a, V8a, V9a. The first eight forward transmission gears V1a-V8a are at least sequentially shiftable under load and thus are sequentially power shiftable. The ninth forward gear V9a is shiftable with interruption of traction and thus is not power shiftable. In this case the first forward transmission gear V1a and the ninth forward transmission gear V9a in each case slipped and thus are formed as a winding gear. Moreover, the dual clutch transmission is provided for shifting of two reverse transmission gears R1a, R2a. In this case the reverse transmission gear R2a is designed as a winding gear.

The dual clutch transmission is designed in the manner of a countershaft. The drive shaft 10a and the output gear wheel are arranged offset parallel to one another. In order to produce an operative connection between the drive shaft 10a and the output gear wheel, the dual clutch transmission comprises two input shafts 11a, 12a, which in each case are linked to one of the power shift clutches K1a, K2a. The power shift clutches K1a, K2a in each case comprise a power shift clutch element on the intake side, which is permanently connected to the drive shaft 10a in a rotationally fixed manner, and a power shift clutch element on the output side. The input shafts 11a, 12a are connected in a rotationally fixed manner to a respective one of the output power shift clutch elements. The first input shaft 11a is associated with the second power shift clutch K2a. The output-side power shift clutch element of the second power shift clutch K2a is permanently connected in a rotationally fixed manner to the first input shaft 11a. The second input shaft 12a is associated with the first power shift clutch K1a. The output-side power shift clutch element of the first power shift clutch K1a is permanently connected in a rotationally fixed manner to the second input shaft 12a.

Furthermore, the dual clutch transmission comprises a first countershaft 13a, which is arranged offset parallel to the input shaft 11a, 12a and the output gear wheel, as well as a second countershaft 14a which is offset parallel to the input shafts 11a, 12a, the output gear wheel and the first countershaft 13a. The drive shaft 10a and the two input shafts 11a, 12a are arranged one behind the other along a main extension direction of the dual clutch transmission. The two input shafts 11a, 12a are arranged coaxially relative to one another, wherein the second input shaft 12a passes through the first input shaft 11a. The first input shaft 11a is designed as a hollow shaft and the second input shaft 12a is designed as a solid shaft. The drive shaft 10a and the input shafts 11a, 12a define a main axis of rotation of the dual clutch transmission. The two countershafts 13a, 14a in each case define an auxiliary axis of rotation. In a sectional plane (not illustrated in greater detail) the main axis of rotation, the auxiliary axes of rotation and an axis of rotation defined by the output gear wheel span a quadrilateral.

The dual clutch transmission has precisely five gear wheel planes Z1a, Z2a, Z3a, Z4a, Z5a. The five gear wheel planes Z1a, Z2a, Z3a, Z4a, Z5a are provided in order to form the nine forward transmission gears V1a-V9a and the two reverse transmission gears R1a, R2a. Furthermore, the dual clutch transmission has precisely one output gear wheel plane Z0a which is provided only for linking of the output gear wheel and thus for delivery of a torque from the dual clutch transmission. The first gear wheel plane Z1a serves in particular for connection of the first input shaft 11a to the first countershaft 13a and for connection of the first input shaft 11a to the second countershaft 14a. The second gear wheel plane Z2a serves in particular for connection of the first input shaft 11a to the first countershaft 13a. The third gear wheel plane Z3a serves in particular for connection of the first input shaft 11a to the second countershaft 14a. The fourth gear wheel plane Z4a serves in particular for connection of the second input shaft 12a to the first countershaft 13a as well as for reversal of the direction of rotation. The fifth gear wheel plane Z5a serves in particular for connection of the second input shaft 12a to the first countershaft 13a and for connection of the second input shaft 12a to the second countershaft 14a.

In principle the dual clutch transmission can be expanded by a hybrid drive module. For example, it is conceivable that the dual clutch transmission has a drive motor permanently linked to the drive shaft 10a. By means of such a drive motor, a starter/generator mode of operation can be implemented, for example. For implementation of further hybrid modes of operation, it is conceivable that the dual clutch transmission has a drive motor linked permanently or shiftably to the drive shaft 14a. Likewise it is conceivable that the dual clutch transmission has a drive motor linked permanently or shiftably to one of the input shafts 11a, 12a.

In relation to the gear wheel planes Z1a, Z2a, Z3a, Z4a, Z5a the output gear wheel plane Z0a is closest to the input clutch. In principle, however, the output gear wheel plane Z0a can be arranged at any location. The output gear wheel plane Z0a comprises two output gear wheels Z01a, Z01a. The first output gear Z01a is arranged coaxially relative to the first countershaft 13a and is permanently connected in a rotationally fixed manner to the first countershaft 13a. The second take-off gear Z02a is arranged coaxially relative to the second countershaft 14a and is permanently connected in a rotationally fixed manner to the second countershaft 14a. Both output gears Z01a, Z02a mesh with the output gear wheel which is not illustrated in greater detail. Both countershafts 13a, 14a are permanently operatively connected to the output gear wheel. In all the forward transmission gears V1a-V9a and in the reverse transmission gears R1a, R2a the output gear wheel plane Z0a is provided to deliver a torque from the dual clutch transmission.

In relation to the rest of the gear wheel planes Z2a, Z3a, Z4a, Z5a the first gear wheel plane Z0a is closest to the input clutch. The first gear wheel plane Z1a comprises a fixed gear Z11a, a first idler gear Z12a and a second idler gear Z13a. The fixed gear Z11a of the first gear wheel plane Z1a is arranged coaxially relative to the input shafts 11a, 12a and is permanently connected in a rotationally fixed manner to the first countershaft 11a. The first idler gear Z12a of the first gear wheel plane Z1A is arranged coaxially relative to the first countershaft 13a and is mounted rotatably on the first countershaft 13a. The second idler gear Z13a of the first gear wheel plane Z1A is arranged coaxially relative to the second countershaft 14a and is mounted rotatably on the second countershaft 14a. The fixed gear Z11a and the first idler gear Z12a form a first gear wheel pair of the first gear wheel plane Z1a which is provided in order to form the forward transmission gear V8a. The fixed gear Z11a and the second idler gear Z13a form a second gear wheel pair of the first gear wheel plane Z1a which is provided in order to form the forward transmission gear V6a. Thus the first gear wheel plane Z1a has two idler gears Z12a, Z13a which are both permanently connected so as to mesh with the fixed gear Z11a of the first gear wheel plane Z1a. Thus the first gear wheel plane Z1a is designed as a double gear wheel plane.

Starting from the input clutch, the second gear wheel plane Z2a is arranged along the main extension direction after the first gear wheel plane Z1a. The second gear wheel plane Z2a has a fixed gear Z21a and only one idler gear Z21a. The fixed gear Z21a of the second gear wheel plane Z2a is arranged coaxially relative to the input shafts 11a, 12a and is permanently connected in a rotationally fixed manner to the first countershaft 11a. The idler gear Z22a of the second gear wheel plane Z2A is arranged coaxially relative to the first countershaft 13a and is mounted rotatably on the first countershaft 13a. The fixed gear Z21a and the idler gear Z22a form a single gear wheel pair of the second gear wheel plane Z2a which is provided in order to form the forward transmission gears V1a, V4a. Thus the second gear wheel plane Z2a has one single idler gear Z22a which is permanently connected so as to mesh with the fixed gear Z21a of the second gear wheel plane Z1a. Thus the second gear wheel plane Z2a is designed as a single gear wheel plane.

Starting from the input clutch, the third gear wheel plane Z3a is arranged along the main extension direction after the second gear wheel plane Z1a. The third gear wheel plane Z3a has a fixed gear Z31a and only one idler gear Z33a. The fixed gear Z31a of the third gear wheel plane Z3a is arranged coaxially relative to the input shafts 11a, 12a and is permanently connected in a rotationally fixed manner to the first input shaft 11a. The idler gear Z33a of the third gear wheel plane Z3A is arranged coaxially relative to the second countershaft 14a and is mounted rotatably on the second countershaft 14a. The fixed gear Z31a and the idler gear Z33a form one single gear wheel pair of the third gear wheel plane Z3a which is provided in order to form the forward transmission gears V1a, V1a. Thus the third gear wheel plane Z3a has one single idler gear Z33a which is permanently connected so as to mesh with the fixed gear Z31a of the third gear wheel plane Z3a. Thus the third gear wheel plane Z3a is designed as a single gear wheel plane.

Starting from the input clutch, the fourth gear wheel plane Z4a is arranged along the main extension direction after the third gear wheel plane Z3a. The fourth gear wheel plane Z4a has a fixed gear Z41a, a first idler gear Z42a and a second idler gear Z43a. The fixed gear Z41a of the fourth gear wheel plane Z4a is arranged coaxially relative to the input shafts 11a, 12a and is permanently connected in a rotationally fixed manner to the second input shaft 11a. The first idler gear Z42a of the fourth gear wheel plane Z4a is arranged coaxially relative to the first countershaft 13a and is mounted rotatably on the first countershaft 13a. The second idler gear Z43a of the fourth gear wheel plane Z4a is arranged coaxially relative to the second countershaft 14a and is mounted rotatably on the second countershaft 14a. The second idler gear Z43a of the fourth gear wheel plane Z4a is only provided in order to form the reverse transmission gears R1a, R2a envisaged. It is provided for reversal of the direction of rotation. The fixed gear Z41a and the idler gear Z42a form a first gear wheel pair of the fourth gear wheel plane Z4a which is provided in order to form the forward transmission gears V1a, V3a and the reverse transmission gears R1a, R1a. The first idler gear Z42a and the second idler gear Z43a form a second gear wheel pair of the fourth gear wheel plane Z4a which is provided together with the first gear wheel pair of the fourth gear wheel plane Z4A in order to form the reverse transmission gears R1a, R1a. The two gear wheel pairs of the fourth gear wheel plane Z4a provide a reversal of the direction of rotation in order to form the reverse transmission gears R1a, R1a. The first idler gear Z42a of the fourth gear wheel plane Z4a and the second idler gear Z43a of the fourth gear wheel plane Z4a form the gear wheel pair for shifting to the reverse transmission gears R1a, R1a. The two idler gears Z42a, Z43a of the fourth gear wheel plane Z4a are provided for shifting to the reverse transmission gears R1a, R1a. Thus the fourth gear wheel plane Z4a has one single idler gear Z42a which is permanently connected so as to mesh with the fixed gear Z41a of the fourth gear wheel plane Z4a. Thus the fourth gear wheel plane Z4a is designed as a single gear wheel plane. In this case the second idler gear plane Z43a of the fourth gear wheel plane Z4a is permanently connected so as to mesh with the first idler gear Z42a which is connected so as to mesh with the fixed gear Z41a of the fourth gear wheel plane Z4a. The first idler gear Z42a of the fourth gear wheel plane Z4a has a single toothing.

Starting from the input clutch, the fifth gear wheel plane Z5a is arranged along the main extension direction after the fourth gear wheel plane Z4a. The fifth gear wheel plane Z5a has a fixed gear Z51a, a first idler gear Z52a and a second idler gear Z53a. The fixed gear Z51a of the fifth gear wheel plane Z5a is arranged coaxially relative to the input shafts 11a, 12a and is permanently connected in a rotationally fixed manner to the second input shaft 12a. The first idler gear Z52a of the fifth gear wheel plane Z5a is arranged coaxially relative to the first countershaft 13a and is mounted rotatably on the first countershaft 13a. The second idler gear Z53a of the fifth gear wheel plane Z5a is arranged coaxially relative to the second countershaft 14a and is mounted rotatably on the second countershaft 14a. The fixed gear Z51a and the first idler gear Z52a form a first gear wheel pair of the fifth gear wheel plane Z5a which is provided in order to form the forward transmission gear V7a. The fixed gear Z51a and the second idler gear Z53a form a second gear wheel pair of the fifth gear wheel plane Z5a which is provided in order to form the forward transmission gear V5a. Thus the fifth gear wheel plane Z5a has two idler gears Z52a, Z53a which are both permanently connected so as to mesh with the fixed gear Z51a of the fifth gear wheel plane Z5a. Thus the fifth gear wheel plane Z5a is designed as a double gear wheel plane.

All the fixed gears Z11a, Z21a, Z31a, Z41a, Z51a of the gear wheel planes Z1a, Z2a, Z3a, Z4a, Z5a are permanently connected in a rotationally fixed manner to one of the input shafts 11a, 11a. In this case three fixed gears Z11a, Z21a, Z31a are permanently connected in a rotationally fixed manner to the first input shaft 11a and two fixed gears Z41a, Z51a are permanently connected in a rotationally fixed manner to the second input shaft 11a. The four idler gear Z12a, Z22a, Z42a, Z52a are arranged coaxially relative to the first countershaft 13a. The four idler gears Z13a, Z33a, Z43a, Z53a are arranged coaxially relative to the second countershaft 14a. Thus four of the total of eight idler gears Z12a, Z13a, Z22a, Z33a, Z42a, Z43a, Z52a, Z53a are arranged coaxially relative to each of the countershafts 13a, 14a. The output gear wheels Z01a, Z02a have different numbers of teeth, resulting in different final drive gear ratios for the two countershafts 13a, 14a. The final drive gear ratio for the first countershaft 13a is longer than the final drive gear ratio for the second countershaft 14a. In principle the fixed gear Z21a, Z31a, Z41a and the idler gear Z22a, Z33a, Z42a, which is permanently connected so as to mesh with the fixed gear Z21a, Z31a, Z41a, of at least one of the gear wheel planes Z2a, Z3a, Z4a designed as single gear wheel planes can be interchanged with one another, so that a dual clutch transmission of equivalent design can be provided.

In order to form the forward transmission gears V1a, V2a, V3a, V4a, V5a, V6a, V7a, V8a, V9a and the reverse transmission gears R1a, R2a the dual clutch transmission comprises precisely nine shift units S1a, S2a, S3a, S4a, S5a, S6a, S7a, S8a, S9a which are provide in order to produce operative connections between the input shafts 11a, 12a and the countershafts 13a, 14a. In connection with the gear wheel planes Z1a-Z5a, the nine shift units S1a-S9a are provided at least constructively for shifting of the nine forward transmission gears V1a, V2a, V3a, V4a, V5a, V6a, V7a, V8a, V9a and the reverse transmission gears R1a, R1a. All the shift units S1a-S9a are arranged coaxially relative to one of the countershafts 13a, 14a. The gear shift units S1a-S9a comprise in each case a first coupling element and a second coupling element which are connected to one another in a rotationally fixed manner. The respective first coupling element of the gear shift units S1a-S9a is designed as a synchronization member which is connected in a rotationally fixed manner to a sliding sleeve, which is arranged on the synchronization member, of the corresponding shift unit S1a-S9a. The respective second coupling element of the gear shift units S1a-S9a has a shift toothing for rotationally fixed connection to the sliding sleeve. The shift units S1a-S9a are preferably designed as synchronized positive clutches. In particular, the shift units S1a-S9a can be designed at least partially as purely positively engaging claw-type gear shift units without frictional synchronization, for example if the dual clutch transmission has a central synchronization arranged on one of the countershafts 13a, 14a and/or the shift units S1a-S9a are synchronized by means of the input clutch. In principle, however, other configurations are also conceivable.

The first eight shift units S1a-58a are in each case provided in order to connect an idler gear Z12a-Z53a in a rotationally fixed manner to one of the countershafts 13a, 14a. The first coupling elements of these eight shift units S1a-S8a are in each case permanently connected in a rotationally fixed manner to one of the countershafts 13a, 14a and the second coupling elements of these eight shift units S1a-S8a are in each case permanently connected in a rotationally fixed manner to one of the idler gears Z12a-Z53a. On the other hand, the ninth shift unit S9a is provided in order to connect two idler gears Z22a, Z42a to one another in a rotationally fixed manner. The first coupling element and the second coupling element of this ninth shift unit S9a are in each case permanently connected in a rotationally fixed manner to an idler gear Z22a, Z41a. The shift units S1a, S2a, the shift units S3a, S4a, the shift units S5a, S6a and the shift units S7a, S8a are in each case combined in pairs. The respectively combined shift units S1a, S2a, S3a, S4a, S5a, S6a, S7a, S8a in each case form a dual shift unit and in each case comprise a common first coupling element and thus a common sliding sleeve which is shifted for shifting the respective one shift unit S1a, S3a, S5a, S7a into a first shift position, for decoupling into a middle neutral position and for shifting the respective other shift unit S2a, S4a, S6a, S8a into a second shift position. The combined shift units S1a, S2a, S3a, S4a, S5a, S6a, S7a, S8a as dual shift units are in each case shiftable only on one side, i.e. in each case only an individual one of the shift units S1a, S2a, S3a, S4a, S5a, S6a, S7a, S8a of a dual shift unit can be shifted. Thus eight of the total of nine shift units 81a-S9a are combined into four dual shift units.

The shift unit S9a is designed as an individual shift unit. The ninth shift unit 59a has a shift position, in which the idler gears Z22a, Z42a are connected to one another in a rotationally fixed manner, and a neutral position, in which the idler gears Z22a, Z42a are decoupled from one another. It comprises a sliding sleeve which can be shifted into the shift position and the neutral position. The shift unit S9a designed as an individual shift unit is in principle shiftable independently of the rest of the shift units S1a-S8a, wherein dependencies can also be defined in accordance with a shifting logic by means of an actuator system for shifting the shift units S1a-S8a.

The first shift unit S1a and the second shift unit S2a, which are combined into a dual shift unit, are arranged coaxially relative to the first countershaft 13a, The gear shift units S1a, S2a are arranged between the first gear wheel plane Z1a and the second gear wheel plane Z1a. The first shift unit S1a is provided in order to connect the first idler gear Z12a of the first gear wheel plane Z1a and the first countershaft 13a to one another in a rotationally fixed manner. The second shift unit S2a is provided in order to connect the idler gear Z22a of the second gear wheel plane and the first countershaft 13a to one another in a rotationally fixed manner. The second coupling element of the first shift unit S1a is permanently connected in a rotationally fixed manner to the first idler gear Z12a of the first gear wheel plane Z1a. The first coupling element, which is associated with two shift units S1a, S2a is permanently connected in a rotationally fixed manner to the first countershaft 13a. The second coupling element S21a of the second shift unit S2a is permanently connected in a rotationally fixed manner to the idler gear Z22a of the second gear wheel plane Z1a. The first coupling element of the gear shift units S1a, S2a is arranged between the second coupling elements of the shift units S1a, S1a. The first shift unit S1a is only engaged in the eighth forward transmission gear V8a. The second shift unit S2a is only engaged in the fourth forward transmission gear V4a.

The third shift unit S3a and the fourth shift unit S4a, which are combined into a dual shift unit, are arranged coaxially relative to the first countershaft 13a. The shift units S3a, S4a are arranged between the fourth gear wheel plane Z4a and the fifth gear wheel plane Z5a. The third shift unit S3a is provided in order to connect the first idler gear Z42a of the fourth gear wheel plane Z4a and the first countershaft 13a to one another in a rotationally fixed manner. The fourth shift unit S3a is provided in order to connect the first idler gear Z42a of the fifth gear wheel plane Z5a and the first countershaft 13a to one another in a rotationally fixed manner. The second coupling element of the third shift unit S3a is permanently connected in a rotationally fixed manner to the first idler gear Z42a of the fourth gear wheel plane Z4a. The first coupling element, which is associated with two shift units S3a, S4a, is permanently connected in a rotationally fixed manner to the first countershaft 13a, the second coupling element of the fourth gear shift unit S4a is permanently connected non-rotatably to the first idler gear Z52a of the fifth gear wheel plane Z5a. The first coupling element of the shift units S3a, S4a is arranged between the second coupling elements of the shift units S3a, S4a. The third shift unit S3a is only engaged in the third forward transmission gear V3a. The fourth shift unit S4a is only engaged in the seventh forward transmission gear V7a and the ninth forward transmission gear V9a.

The fifth shift unit S5a and the sixth shift unit S6a, which are combined into a dual shift unit, are arranged coaxially relative to the second countershaft 14a. The gear shift units S5a, S6a are arranged between the first gear wheel plane Z1a and the third gear wheel plane Z3a. The fifth shift unit S5a is provided in order to connect the second idler gear Z13a of the first gear wheel plane Z1a and the second countershaft 14a to one another in a rotationally fixed manner. The sixth shift unit S6a is provided in order to connect the idler gear Z33a of the third gear wheel plane Z3a and the second countershaft 14a to one another in a rotationally fixed manner. The second coupling element of the fifth shift unit S5a is permanently connected in a rotationally fixed manner to the second idler gear Z13a of the first gear wheel plane Z1a. The first coupling element, which is associated with two shift units S5a, S6a, is permanently connected in a rotationally fixed manner to the second countershaft 14a. The second coupling element of the sixth gear shift unit S6a is permanently connected in a rotationally fixed manner to the idler gear Z33a of the third gear wheel plane Z3a. The first coupling element of the shift units S5a, S6a is arranged between the second coupling elements of the shift units S5a, S6a. The fifth shift unit S5a is only engaged in the sixth forward transmission gear V6a. The sixth shift unit S6a is only engaged in the first forward transmission gear Via and the second forward transmission gear V2a.

The seventh shift unit S7a and the eighth shift unit S8a, which are combined into a dual shift unit, are arranged coaxially relative to the second countershaft 14a. The shift units S7a, S8a are arranged between the fourth gear wheel plane Z4a and the fifth gear wheel plane Z5a. The seventh shift unit S7a is provided in order to connect the second idler gear Z43a of the fourth gear wheel plane Z4a and the second countershaft 14a to one another in a rotationally fixed manner. The eighth shift unit S8a is provided in order to connect the second idler gear Z53a of the fifth gear wheel plane Z5a and the second countershaft 14a to one another in a rotationally fixed manner. The second coupling element of the seventh shift unit S7a is permanently connected in a rotationally fixed manner to the second idler gear Z43a of the fourth gear wheel plane Z4a. The first coupling element, which is associated with two shift units S7a. S8a, is permanently connected in a rotationally fixed manner to the second countershaft 14a. The second coupling element of the eighth gear shift unit S8a is permanently connected in a rotationally fixed manner to the second idler gear Z53a of the fifth gear wheel plane Z5a. The first coupling element of the shift units 37a, S8a is arranged between the second coupling elements of the shift units S7a, S8a. The seventh shift unit S7a is only engaged in the reverse transmission gears R1a, R1a. It is only provided in order to form the reverse transmission gears R1a, R1a. The eighth shift unit S8a is only engaged in the fifth forward transmission gear V5a.

The ninth shift unit S9a is arranged coaxially relative to the first countershaft 14a. The ninth shift unit S9a is arranged between the second gear wheel plane Z2a and the fourth gear wheel plane Z4a. The ninth shift unit S3a is provided in order to connect the idler gear Z22a of the second gear wheel plane Z2a and the first idler gear Z42a of the fourth gear wheel plane Z4a to one another in a rotationally fixed manner. The first coupling element of the ninth shift unit S9a is permanently connected in a rotationally fixed manner to the idler gear Z22a of the second gear wheel plane Z1a. The second coupling element of the ninth shift unit S9a is permanently connected in a rotationally fixed manner to the first idler gear Z42a of the fourth gear wheel plane Z4a. The ninth shift unit S9a is only engaged in the first forward transmission gear V1a, the ninth forward transmission gear V9a and the reverse transmission gear R1a. The ninth shift unit S9a is only engaged in the winding gears.

A shift logic for the forward transmission gears V1a-V9a and the reverse transmission gears R1a, R2a is disclosed by the description of the drawings. In this case neighboring forward transmission gears V1a-V8a are in principle power shiftable amongst themselves. For power shifting the forward transmission gear V1a-V8a to be shifted is formed by engaging the corresponding shift units S1a, 32a, S3a, S4a, S5a, S6a, S8a, 39a. Then the one of the power shift clutches K1a, K2a, which is associated with the forward transmission gear V1a-V8a to be shifted, is successively engaged, whilst at the same time the other power shift clutch K1a, K2a, which is associated with the forward transmission gear V1a-V8a to be deactivated, is successively disengaged.

The odd-numbered power shiftable forward transmission gears V1a, V3a, V5a, V7a are associated with the first power shift clutch K1a. The even-numbered shiftable forward transmission gears V2a, V4a, V6a, V8a are associated with the second power shift clutch K1a. The second power shift clutch K2a is associated with the ninth forward transmission gear V9a which is not power shiftable. The first power shift clutch K1a is associated with the reverse transmission gear R1a. The second power shift clutch K2a is associated with the reverse transmission gear R1a. The first power shift clutch K1a is engaged in the forward transmission gears V1a, V3a, V5a, V7a and the reverse transmission gear R1a. The second power shift clutch K2a is engaged in the forward transmission gears V2a, V4a, V6a, V8a, V9a and the reverse transmission gear R1a. Additionally possible power shifts between the forward transmission gears V1a-V8a, which go beyond a purely sequential power shift capability, result directly from the shift logic.

FIG. 2 shows a shift diagram of the dual clutch transmission. The dual clutch transmission is automated process or partially automated. In the shift diagram an “x” represents an engaged shift unit or an engaged power shift clutch in the corresponding transmission gear. The formation of the forward transmission gears V1-V9 and of the reverse gears R1a, R2a by closure of the coupling units S1a-S6a is illustrated in the shift diagram in FIG. 2.

The first forward transmission gear V1a, the ninth forward transmission gear V9a and the reverse transmission gear R2a are designed as winding gears. In the forward transmission gear V1a the sixth shift unit S6a and the ninth shift unit S9a are engaged. A power flow in the first forward transmission gear V1a is transmitted by means of the first gear wheel pair of the fourth gear wheel plane Z4a, the gear wheel pair of the second gear wheel plane Z2a and the gear wheel pair of the third gear wheel plane Z3a. In the ninth forward transmission gear V9a the fourth shift unit S4a and the ninth shift unit S9a are engaged. A power flow in the ninth forward transmission gear V9a is transmitted by means of the gear wheel pair of the second gear wheel plane Z2a, the first gear wheel pair of the fourth gear wheel plane Z2a and the first gear wheel pair of the fifth gear wheel plane Z5a. In the reverse transmission gear R2a the seventh shift unit S7a and the ninth shift unit S9a are engaged. A power flow in the reverse transmission gear R2a is transmitted by means of the gear wheel pair of the second gear wheel plane Z2a and the gear wheel pair of the fourth gear wheel plane Z4a provided for the reverse transmission gear.

The dual clutch transmission comprises three winding stages which are provided in order to form the two forward transmission gears V1a, V9a which can be at least constructively shifted and the reverse transmission gear R2a which can be at least constructively shifted. The first idler gear Z42a of the fourth gear wheel plane Z4a and the idler gear Z22a of the second gear wheel plane Z2a, which are coupled to one another in the forward transmission gears V1a, V9a as well as the reverse transmission gear R2a by means of the shift unit S9a and which transmit a power flow, form the first winding stage. The fixed gear Z21a of the second gear wheel plane Z2a and the fixed gear Z31a of the third gear wheel plane Z3a, which are permanently coupled to one another by means of the first input shaft 11a and which transmit a power flow in the first forward transmission gear V1a, form the second winding stage. The fixed gear Z41a of the fourth gear wheel plane Z4a and the fixed gear Z51a of the fifth gear wheel plane Z5a, which are permanently coupled to one another by means of the second input shaft 12a and which transmit a power flow in the ninth forward transmission gear V9a, form the third winding stage. The first forward gear V1a is formed by the first winding stage and the second winding stage, the ninth forward transmission gear V9a is formed the first winding stage and the third winding stage, and the reverse transmission gear R2a is formed by the first winding stage. Thus the idler gear Z22a of the second gear wheel plane Z2a and the first idler gear Z42a of the fourth gear wheel plane V1a form a winding stage for the first forward transmission gear V1a, the ninth forward transmission gear V9a and the reverse transmission gear R1a. The first winding stage can be activated by the ninth shift unit S9a. In the rest of the forward transmission gears V2a-V8a, in each case only one of the gear wheel pairs of the gear wheel planes Z1a, Z2a, Z3a, Z4a, Z5a participate in a transmission. The formation of the rest of the forward transmission gears V2a-V8a by engagement of the shift units S1-S8a and the formation of the reverse transmission gear R1a by engagement of the shift unit S7a is illustrated in FIG. 2.

The nine gear shift units S1a-S9a of the dual clutch transmission have a total of five sliding sleeves. In order to shift the sliding sleeves of the shift units S1a-S8a which are designed as dual shift units, the dual clutch transmission in each case has a hydraulic shift actuator. A further hydraulic shift actuator is provided for the ninth shift unit S9a. Thus the dual clutch transmission comprises five shift actuators (not illustrated in greater detail) for shifting the five sliding sleeves. In principle, however, a configuration with more shift actuators is also conceivable. In this case the shift actuators can be designed for example in the form of double acting cylinders. However, electric or pneumatic shift actuators are also conceivable for shifting the sliding sleeves.

For positively engaged locking the dual clutch transmission has a parking brake wheel 15a. In principle the parking brake wheel 15a can be arranged at different positions. The parking brake wheel 15a is preferably permanently connected in a rotationally fixed manner to the second countershaft 14a, which has a shorter final drive gear ratio than the first countershaft 13a. In principle, however, it can be permanently connected in a rotationally fixed manner to the first countershaft 13a. The parking brake wheel 15a is preferably arranged on a side of the fifth gear wheel plane Z5a facing away from the input clutch,

Three further exemplary embodiments of the invention are shown in FIGS. 3 to 7. The following descriptions are limited substantially to the differences between the exemplary embodiments, wherein with regard to components, features and functions which are the same, reference may be made to the description of the other exemplary embodiments, in particular according to FIGS. 1 and 2. In order to distinguish between the exemplary embodiments, the letter “a” in the reference signs of the exemplary embodiment shown in FIGS. 1 to 2 is replaced by the letters “b” to “d” in the reference signs of the exemplary embodiments shown in FIGS. 3 to 7. With regard to components with the same designations, in particular with regard to components with the same reference signs, reference may be made in principle to the drawings and/or the description of the other exemplary embodiments, in particular according to FIGS. 1 and 2.

FIG. 3 shows a dual clutch transmission of alternative design for a motor vehicle. The dual clutch transmission is provided for shifting of nine forward transmission gears V1-V9 and two reverse transmission gears R1, R2. The dual clutch transmission comprises a drive shaft 10b, an input clutch linked to the drive shaft 10b and having two power shift clutches K1b, K2b, a first input shaft 11b linked to the second power shift clutch K2b, a second input shaft 12b which is linked to the first power shift clutch K1b and passes through the first input shaft 11b, as well as two countershafts 13b, 14b arranged offset parallel to the input shafts 11b, 12b. In order to form the nine forward transmission gears V1-V9 and the reverse transmission gears R1, R2, the dual clutch transmission comprises five gear wheel planes Z1b, Z2b, Z3b, Z4b, Z5b, which in each case have a fixed gear Z11b, Z21b, Z31b, Z41b, Z51b permanently connected in a rotationally fixed manner to one of the input shafts 11b, 12b, and nine gear shift units S1b, S2b, S3b, S4b, S5b, S6b, S7b, 58b, S9b. The gear wheel planes Z1b, Z2b, Z3b, Z4b, Z5b in each case have at least one idler gear Z12b, Z13b, Z22b, Z33b, Z42b, Z43b, Z52b, Z53b, wherein the idler gears Z12b, Z22b, Z42b, Z52b are arranged coaxially relative to the first countershaft 13b and the idler gear Z13b, Z33b, Z43b, Z53b are arranged coaxially relative to the second countershaft 14b, For shifting of the reverse transmission gears R1, R2, the idler gear Z42b, arranged coaxially relative to the first countershaft 13b, of the fourth gear wheel plane Z4b and the idler gear Z43b, arranged coaxially relative to the second countershaft 14b, of the fourth gear wheel plane Z4b form a gear wheel pair for shifting of the reverse transmission gears R1, R2. Furthermore, for delivery of a torque the dual clutch transmission has an output gear wheel plane Z0b which comprises an output gear wheel Z01b permanently connected in a rotationally fixed manner to the first countershaft 13b and an output gear Z02b permanently connected in a rotationally fixed manner to the second countershaft 14b. Moreover, the dual clutch transmission has a parking brake wheel 15b. The first eight forward transmission gears V1-V8 are sequentially power shiftable and the ninth forward transmission gear V9 is not power shiftable.

In contrast to the preceding exemplary embodiment the first idler gear Z42b of the fourth gear wheel plane Z4b has a dual toothing. The fixed gear Z41b of the fourth gear wheel plane Z4b and the second idler gear Z43b of the fourth gear wheel plane Z4b are offset axially relative to one another and are permanently connected so as to mesh with the first idler gear Z42b of the fourth gear wheel plane Z4b. The first gear wheel Z42b of the fourth gear wheel plane Z4b comprises a first toothing for the fixed gear Z41b of the fourth gear wheel plane Z4b and an axially offset second toothing for the second idler gear Z43b of the fourth gear wheel plane Z4b. The first gear wheel Z42b of the fourth gear wheel plane Z4b and the fixed gear Z41b of the fourth gear wheel plane Z4b are permanently connected to one another so as to mesh by means of the first toothing. The first gear wheel Z42b of the fourth gear wheel plane Z4b and the second idler gear Z43b of the fourth gear wheel plane Z4b are permanently connected to one another so as to mesh by means of the second toothing. The two toothings differ in the number of teeth and/or a pitch diameter. By means of the first toothing of the first idler gear Z42b the fixed gear Z41b and the first idler gear Z42b of the fourth gear wheel plane Z4b form a gear wheel pair for shifting of the first and third forward transmission gears V1, V3. By means of the second toothing of the first idler gear Z42b the first idler gear Z42b and the second idler gear Z43b of the fourth gear wheel plane Z4b form a gear wheel pair for shifting of the reverse transmission gears R1, R2.

FIG. 4 shows a third exemplary embodiment of a dual clutch transmission of a motor vehicle which is kinematically related to the dual clutch transmission illustrated in FIGS. 1 and 2 and the dual clutch transmission illustrated in FIG. 3. The dual clutch transmission is provided for shifting of eight sequentially power shiftable forward transmission gears V1c-V8c and two reverse transmission gears R1c, R2c. Furthermore, the dual clutch transmission is provided for shifting of a crawler gear which cannot be power shifted C1c.

The dual clutch transmission comprises a drive shaft 10c, an input clutch linked to the drive shaft 10c and having two power shift clutches K1c, K2c, a first input shaft 11c linked to the second power shift clutch K2c, a second input shaft 12c which is linked to the first power shift clutch K1b and passes through the first input shaft 11c, as well as two countershafts 13c, 14c arranged offset parallel to the input shafts 11c, 12c. In order to form the eight forward transmission gears V1c-V8c, the reverse transmission gears R1c, R2c and the crawler gear C1c, the dual clutch transmission comprises five gear wheel planes Z1c, Z2c, Z3c, Z4c, Z5c, which in each case have a fixed gear Z11c, Z21c, Z31c, Z41c, Z51c permanently connected in a rotationally fixed manner to one of the input shafts 11c, 12c, and nine shift units S1c, S2c, S3c, S4c, S5c, S6c, S7c, S8c, S9c. The gear wheel planes Z1c, Z2c, Z3c, Z4c, Z5c in each case have at least one idler gear Z12c, Z13c, Z22c, Z33c, Z42c, Z43c, Z52c, Z53c, wherein the idler gears Z12c, Z22c, Z42c, Z52c are arranged coaxially relative to the first countershaft 13c and the idler gears Z13c, Z33c, Z43c, Z53c are arranged coaxially relative to the second countershaft 14c. For shifting of the reverse transmission gears R1c, R2c, the idler gear Z42c, arranged coaxially relative to the first countershaft 13c, of the fourth gear wheel plane Z4c and the idler gear Z43c, arranged coaxially relative to the second countershaft 14c, of the fourth gear wheel plane Z4b form a gear wheel pair for shifting of the reverse transmission gears R1c, R2c. For delivery of a torque the dual clutch transmission has an output gear wheel plane Z0c with two output gear wheels Z01c, Z02c. Moreover, the dual clutch transmission has a parking brake wheel 15c.

In contrast to the preceding exemplary embodiments one of the output gear wheels Z01c, Z02c is mounted rotatably on one of the countershafts 13c, 14c and one of the output gears Z01c, Z02c is arranged permanently in a rotationally fixed manner on the other countershaft 13c, 14c. The first idler gear Z01c is arranged coaxially relative to the first countershaft 13c and is mounted rotatably on the first countershaft 13c. The second output gear Z02c is arranged coaxially relative to the second countershaft 14c and is permanently connected in a rotationally fixed manner to the second countershaft 14c. Only the second countershaft 14c is permanently operatively connected to an output gear wheel of the dual clutch transmission. The first countershaft 13c can be shiftably decoupled from the output gear wheel.

In a further contrast to the preceding exemplary embodiments the ninth shift unit S9c is provided in order to produce an operative connection between the first countershaft 13c and the output gear wheel (not illustrated in greater detail). The ninth shift unit S9c is provided in order to produce an operative connection between the first output gear Z01c, which is arranged coaxially relative to the first countershaft 13c, and the first countershaft 13c. The ninth shift unit S9c is arranged on a side of the first output gear Z01c facing away from the input clutch. It is arranged between the first gear wheel plane Z1c and the first output gear Z01c. The ninth shift unit S9c is provided in order, in a shift position, to connect the first output gear Z01c of the output gear wheel plane Z0c and the first countershaft 13c to one another in a rotationally fixed manner and, in a neutral position, to decouple the first output gear Z01c and the first countershaft 13c from one another. A first coupling element of the ninth shift unit S9c is permanently connected in a rotationally fixed manner to the first countershaft 13c. A second coupling element of the ninth shift unit S9c is permanently connected in a rotationally fixed manner to the first output gear Z01c of the output gear wheel plane Z0c. The dual clutch transmission lacks a shift unit which is provided in order to connect two idler gears to one another in a rotationally fixed manner.

A shift diagram of the dual clutch transmission is shown in FIG. 5. The first power shift clutch K1c is engaged in the odd-numbered forward transmission gears V1c, V3c, V5c, V7c, the crawler gear C1c and the reverse transmission gear R1c. The second power shift clutch K2c is engaged in the even-numbered forward transmission gears V2c, V4c, V6c, V8c and the reverse transmission gear R2c. In the first forward transmission gear V1c only the shift units S2c, S3c, S6c are engaged. In the second forward transmission gear V2c only the shift unit S6c is engaged. In the third forward transmission gear V3c only the shift units S3c, S9c are engaged. In the fourth forward transmission gear V4c only the shift units S2c, S9c are engaged. In the fifth forward transmission gear V5c only the shift unit S8c is engaged. In the sixth forward transmission gear V6c only the shift unit S5c engaged. In the seventh forward transmission gear V7c only the shift units S4c, S9c are engaged. In the eighth forward transmission gear V8c only the shift units S1c, S9c are engaged. In the crawler gear C1c only the shift units S1c, S3c, S6c are engaged. In the reverse transmission gear R1c only the shift unit S7c is engaged. In the reverse transmission gear R2c only the shift units S2c, S4c, S7c are engaged.

The first forward transmission gear V1c, the crawler gear C1c and the reverse transmission gear R2c are designed as winding gears. A power flow in the first forward transmission gear V1c is transmitted by means of a first gear wheel pair of the fourth gear wheel plane Z4c, a gear wheel pair of the second gear wheel plane Z2c and a gear wheel pair of the third gear wheel plane Z3c. A power flow in the first crawler gear C1c is transmitted by means of the first gear wheel pair of the fourth gear wheel plane Z4c, a first gear wheel pair of the first gear wheel plane Z1c and the gear wheel pair of the third gear wheel plane Z3c. A power flow in the reverse transmission gear R2c is transmitted by means of the gear wheel pair of the second gear wheel plane Z2c, a first gear wheel pair of the fifth gear wheel plane Z5c and the gear wheel pair of the fourth gear wheel plane Z4c provided for the reverse transmission gear.

The dual clutch transmission comprises six winding stages which are provided in order to form the forward transmission gear V1c, which can be at least constructively shifted, and the reverse transmission gear R2c, which can be at least constructively shifted. The first winding stage is formed by the first idler gear Z42c of the fourth gear wheel plane Z4c and the idler gear Z22c of the second gear wheel plane Z2c, which are coupled to one another in the forward transmission gear V1c by means of the shift units S2c, S3c via the first countershaft 13c and which transmit a power flow. In this case the first countershaft 13c and thus the idler gears Z42c, Z22c which are coupled to one another are decoupled from the first output gear Z01c by the ninth shift unit S9a. The second winding stage is formed by the fixed gear Z21c of the second gear wheel plane Z2c and the fixed gear Z31c of the third gear wheel plane Z3c, which are permanently coupled to one another by means of the first input shaft 11c and which transmit a power flow in the first forward transmission gear V1c. The third winding stage is formed by the first idler gear Z42c of the fourth gear wheel plane Z4c and the first idler gear Z12c of the first gear wheel plane Z1c, which are coupled to one another in the crawler gear C1c by means of the shift units S1c, S3c via the first countershaft 13c and which transmit a power flow. In this case the first countershaft 13c and thus the idler gears Z42c, Z12c which are coupled to one another are decoupled from the first output gear Z01c by the ninth shift unit S9c. The fourth winding stage is formed by the fixed gear Z11c of the first gear wheel plane Z1c and the fixed gear Z31c of the third gear wheel plane Z3c, which are permanently coupled to one another by means of the first input shaft 11c and which transmit a power flow in the crawler gear C1c. The fifth winding stage is formed by the idler gear Z22c of the second gear wheel plane Z2c and the first idler gear Z52c of the fifth gear wheel plane Z5c, which are coupled to one another in the reverse transmission gear R2c by means of the shift units S2c, S4c via the first countershaft 13c and which transmit a power flow. In this case the first countershaft 13c and thus the idler gears Z22c, Z52c which are coupled to one another are decoupled from the first output gear Z01c by the ninth shift unit S9a. The sixth winding stage is formed by the fixed gear Z51c of the fifth gear wheel plane Z5c and the fixed gear Z41c of the fourth gear wheel plane Z4c, which are permanently coupled to one another by means of the second input shaft 12c and which transmit a power flow in the reverse transmission gear R2c. The fourth forward gear V1c is formed by the first winding stage and the second winding stage, the crawler gear C1c is formed by the third winding stage and the fourth winding stage, and the reverse transmission gear R2c is formed by the fifth winding stage and the sixth winding stage. The first winding stage can be activated by the shift units S2c, S3c, the third winding stage can be activated by the shift units S1c, S3c and the fifth winding stage can be activated by the shift units S2c, S4c with the first output gear Z01c decoupled.

FIG. 6 shows a fourth exemplary embodiment of a dual clutch transmission of a motor vehicle which is kinematically related to the dual clutch transmission illustrated in FIGS. 4 and 5. A shift diagram of the dual clutch transmission is shown in FIG. 7. The dual clutch transmission is provided for shifting of eight sequentially power shiftable forward transmission gears V1d-V8d and two reverse transmission gears R1d, R2d. Furthermore, the dual clutch transmission is provided for shifting of a crawler gear C1d.

The dual clutch transmission comprises a drive shaft 10d, an input clutch linked to the drive shaft 10d and having two power shift clutches K1d, K2d, a first input shaft 11d linked to the second power shift clutch K2d, a second input shaft 12d which is linked to the first power shift clutch K1d and passes through the first input shaft 11d, as well as two countershafts 13d, 14d arranged offset parallel to the input shafts 11d, 12d. In order to form the eighth forward transmission gears V1d-V8d, the reverse transmission gears R1d, R2d and of the crawler gear C1d, the dual clutch transmission comprises five gear planes Z1d, Z2d, Z3d, Z4d, Z5d and nine shift units S1d, S2d, S3d, S4d, S5d, S6d, S7d, S8d, S9d. In order to deliver a torque, the dual clutch transmission has an output gear plane Z0d with two output gears Z01d, Z02d, wherein the first output gear Z01d is arranged coaxially relative to the first countershaft 13d and is rotatably mounted on the first countershaft 13d, and the second output gear Z02d is arranged coaxially relative to the second countershaft 14d and is permanently connected in a rotationally fixed manner to the second countershaft 14d.

In contrast to the preceding exemplary embodiment the five gear sZ1d, Z2d, Z3d, Z4d, Z5d are arranged differently. In relation to the rest of the gear wheel planes Z1d, Z2d, Z4d, Z5d the third gear wheel plane Z3d is closest to the input clutch. The third gear wheel plane Z3d has a fixed gear Z31d and an idler gear Z33d. The fixed gear Z31d is arranged coaxially relative to the input shafts 11d, 12d and is permanently connected in a rotationally fixed manner to the first input shaft 11d. The idler gear Z33d is arranged coaxially relative to the second countershaft 14d and is mounted rotatably on the second countershaft 14d. The fixed gear Z31d and the idler gear Z33d form one single gear wheel pair of the third gear wheel plane Z3d which is provided in order to form only the forward transmission gears V1d, V2d.

Starting from the input clutch, the second gear wheel plane Z2d is arranged along the main extension direction after the third gear wheel plane Z3d. The second gear wheel plane Z2d has a fixed gear wheel Z21d and an idler gear Z22d. The fixed gear Z21d is arranged coaxially relative to the input shafts 11d, 12d and is permanently connected in a rotationally fixed manner to the first input shaft 11d. The idler gear Z22d is arranged coaxially relative to the first countershaft 13d and is mounted rotatably on the first countershaft 13d. The fixed gear Z21d and the idler gear Z22d form one single gear wheel pair of the second gear wheel plane Z2d which is provided in order to form only the forward transmission gear V4d. The ninth shift unit S9d, which is provided for the operative connection between the first output gear Z01d and the first countershaft 13d, is arranged between the second gear wheel plane Z2d and the output gear wheel plane Z0d.

Starting from the input clutch, the first gear wheel plane Z1d is arranged along the main extension direction after the second gear wheel plane Z2d. The first gear wheel plane Z1d comprises a fixed gear Z11d, a first idler gear Z12d and a second idler gear Z13d. The fixed gear Z11d is arranged coaxially relative to the input shafts 11d, 12d and is permanently connected in a rotationally fixed manner to the first input shaft 11d. The first idler gear Z12d is arranged coaxially relative to the first countershaft 13d and is mounted rotatably on the first countershaft 13d. The second idler gear Z13d is arranged coaxially relative to the second countershaft 14d and is mounted rotatably on the second countershaft 14d. The fixed gear Z11d and the first idler gear Z12d form a first gear wheel pair of the first gear wheel plane Z1d which is provided in order to form only the forward transmission gear V8d. The fixed gear Z11d and the second idler gear Z13d form a second gear wheel pair of the first gear wheel plane Z1d which is provided in order to form only the forward transmission gear V6.

Starting from the input clutch, the fifth gear wheel plane Z5d is arranged along the main extension direction after the first gear wheel plane Z1d. The fifth gear wheel plane Z5d has a fixed gear Z51d, a first idler gear Z52d and a second idler gear Z53d. The fixed gear Z51d is arranged coaxially relative to the input shafts 11d, 12d and is permanently connected in a rotationally fixed manner to the second input shaft 12d. The first idler gear Z52d is arranged coaxially relative to the first countershaft 13d and is mounted rotatably on the first countershaft 13d. The second idler gear Z53d is arranged coaxially relative to the second countershaft 14d and is mounted rotatably on the second countershaft 14d. The fixed gear Z51d and the first idler gear Z52d form a first gear wheel pair of the fifth gear wheel plane Z5d which is provided in order to form only the forward transmission gear V7d. The fixed gear Z51d and the second idler gear Z53d form a second gear wheel pair of the fifth gear wheel plane Z5d which is provided in order to form only the forward transmission gear V5d.

Starting from the input clutch, the fourth gear wheel plane Z4d is arranged along the main extension direction after the fifth gear wheel plane Z5d. The fourth gear wheel plane Z4d has a fixed gear Z41d, a first idler gear Z42d and second idler gear Z43d. The fixed gear Z41d is arranged coaxially relative to the input shafts 11d, 12d and is permanently connected in a rotationally fixed manner to the second input shaft 12d. The first idler gear Z42d is arranged coaxially relative to the first countershaft 13d and is mounted rotatably on the first countershaft 13d. The second idler gear Z43d is arranged coaxially relative to the second countershaft 14d and is mounted rotatably on the second countershaft 14d. The fixed gear Z41d and the first idler gear Z42d form a first gear wheel pair of the fourth gear wheel plane Z4d which is provided in order to form only the forward transmission gear V3d. The first idler gear Z42d and the second idler wheel Z43d form a second gear wheel pair of the fourth gear wheel plane Z4d which is provided together with the first gear wheel pair of the fourth gear wheel plane Z4d in order to form only the reverse transmission gears R1d, R2d. The two gear wheel pairs of the fourth gear wheel plane Z4d provide a reversal of the direction of rotation in order to form the reverse transmission gears R1d, R2d. The idler gears Z42d, Z43d of the fourth gear wheel plane Z4d form a gear wheel pair for shifting the reverse transmission gears R1d, R2d.

FIG. 8 shows a fifth exemplary embodiment of a dual clutch transmission of a motor vehicle which is kinematically related to the dual clutch transmissions illustrated in FIGS. 4 to 7. A shift diagram of the dual clutch transmission is shown in FIG. 9. The dual clutch transmission is provided for shifting of eight sequentially power shiftable forward transmission gears V1e-V8e and two reverse transmission gears R1e, R2e. Furthermore, the dual clutch transmission is provided for shifting of an overdrive O1e, so that a fuel saving forward transmission gear can be provided.

The dual clutch transmission comprises a drive shaft 10e, an input clutch linked to the drive shaft 10e and having two power shift clutches K1e, K2e, a first input shaft 11e linked to the second power shift clutch K2e, a second input shaft 12e which is linked to the first power shift clutch K1e and passes through the first input shaft 11e, as well as two countershafts 13e, 14e arranged offset parallel to the input shafts 11e, 12e. In order to form the eighth forward transmission gears V1e-V8e, the reverse transmission gears R1e, R2e and the overdrive O1e, the dual clutch transmission comprises five gear levels Z1e, Z2e, Z3e, Z4e, Z5e and nine shift units S1e, S2e, S3e, S4e, S5e, S6e, S7e, S8e, S9e. In order to deliver a torque, the dual clutch transmission has an output gear plane Z0e with two output gears Z01e, Z02e, wherein the first output gear Z01e is arranged coaxially relative to the first countershaft 13e and is rotatably mounted on the first countershaft 13e, and the second output gear Z02e is arranged coaxially relative to the second countershaft 14e and is permanently connected in a rotationally fixed manner to the second countershaft 14e.

In contrast to the exemplary embodiment according to FIG. 4 the five gear wheel planes Z1e, Z2e, Z3e, Z4e, Z5e are arranged differently. In relation to the rest of the gear wheel planes Z1e, Z3e, Z4e, Z5e the second gear wheel plane Z2e is closest to the input clutch. The second gear wheel plane Z2e has a fixed gear Z21e and an idler gear Z22e. The fixed gear Z21e is arranged coaxially relative to the input shafts 11e, 12e and is permanently connected in a rotationally fixed manner to the first input shaft 11e. The idler gear Z22e is arranged coaxially relative to the first countershaft 13e and is mounted rotatably on the first countershaft 13e. The fixed gear Z21a and the idler gear Z22e form a single gear wheel pair of the second gear wheel plane Z2a which is provided in order to form only the first forward transmission gear V1a and the eighth forward transmission gear V8e.

Starting from the input clutch, the third gear wheel plane Z3e is arranged along a main extension direction after the second gear wheel plane Z2e. The third gear wheel plane Z3e has a fixed gear Z31e and an idler gear Z33e. The fixed gear Z31e is arranged coaxially relative to the input shafts 11e, 12e and is permanently connected in a rotationally fixed manner to the first input shaft 11e. The idler gear Z33e is arranged coaxially relative to the second countershaft 14e and is mounted rotatably on the second countershaft 14e. The fixed gear Z31e and the idler gear Z33e form one single gear wheel pair of the third gear wheel plane Z3e which is provided in order to form only the forward transmission gears V1e, V2e and the reverse transmission gear R1e.

Starting from the input clutch, the first gear wheel plane Z1e is arranged along the main extension direction after the third gear wheel plane Z3e. The first gear wheel plane Z1e comprises a fixed gear Z11e, a first idler gear Z12e and a second idler gear Z13e. The fixed gear Z11e is arranged coaxially relative to the input shafts 11e, 12e and is permanently connected in a rotationally fixed manner to the first input shaft 11e. The first idler gear Z12e is arranged coaxially relative to the first countershaft 13e and is mounted rotatably on the first countershaft 13e. The second idler gear Z13e is arranged coaxially relative to the second countershaft 14e and is mounted rotatably on the second countershaft 14e. The fixed gear Z11e and the first idler gear Z12e form a first gear wheel pair of the first gear wheel plane Z1e which is provided in order to form only the forward transmission gear V4e and the reverse transmission gear R1e. The fixed gear Z11e and the second idler gear Z13e form a second gear wheel pair of the first gear wheel plane Z1e which is provided in order to form only the forward transmission gear V6e.

Starting from the input clutch, the fifth gear wheel plane Z5e is arranged along the main extension direction after the first gear wheel plane Z1e. The fifth gear wheel plane Z5e has a fixed gear Z51e, a first idler gear Z52e and a second idler gear Z53e. The fixed gear Z51e is arranged coaxially relative to the input shafts 11e, 12e and is permanently connected in a rotationally fixed manner to the second input shaft 12e. The first idler gear Z52e is arranged coaxially relative to the first countershaft 13e and is mounted rotatably on the first countershaft 13e. The second idler gear Z53e is arranged coaxially relative to the second countershaft 14e and is mounted rotatably on the second countershaft 14e. The fixed gear Z51e and the first idler gear Z52e form a first gear wheel pair of the fifth gear wheel plane Z5e which is provided in order to form only the forward transmission gear V5e. The fixed gear Z51e and the second idler gear Z53e form a second gear wheel pair of the fifth gear wheel plane Z5e which is provided in order to form only the forward transmission gear V7e.

Starting from the input clutch, the fourth gear wheel plane Z4e is arranged along the main extension direction after the fifth gear wheel plane Z5e. The fourth gear wheel plane Z4e has a fixed gear Z41e, a first idler gear Z42e and second idler gear Z43e. The fixed gear Z41e is arranged coaxially relative to the input shafts 11e, 12e and is permanently connected in a rotationally fixed manner to the second input shaft 12e. The first idler gear Z42e is arranged coaxially relative to the first countershaft 13e and is mounted rotatably on the first countershaft 13e. The first idler gear Z42e of the fourth gear wheel plane Z4e is only provided in order to form the reverse transmission gears R1e, R2e. It is provided for reversal of the direction of rotation. The second idler gear Z43e is arranged coaxially relative to the second countershaft 14e and is mounted rotatably on the second countershaft 14e. The first idler gear Z42e and the second idler gear Z43e form a first gear wheel pair of the fourth gear wheel plane Z4e in order to form only the reverse transmission gears R1e, R2e. The fixed gear Z41e and the second idler gear Z43e form a first gear wheel pair of the fourth gear wheel plane Z4e which is provided in order to form the forward transmission gear V3e. The first gear wheel pair of the fourth gear wheel plane Z4e is provided together with the second gear wheel pair in order to form the reverse transmission gears R1e, R2e. The two gear wheel pairs of the fourth gear wheel plane Z4e provide a reversal of the direction of rotation in order to form the reverse transmission gears R1e, R2e.

In a further contrast to the exemplary embodiment according to FIG. 4 the ninth shift unit S9e, which is provided for operative connection between the first output gear Z01e and the first countershaft 13e, is arrange on a side of the first output gear Z01e facing the input clutch.

1. A dual clutch transmission comprising two input shafts (11a, 12a; 11b, 12b) which are provided for respectively linking to a power shift clutch (K1a, K2a; K1b, K2b), a first countershaft (13a; 13b) arranged offset parallel to the input shafts (11a, 12a; 11b, 12b), a second countershaft (14a; 14b) arranged offset parallel to the input shafts (11a, 12a; 11b, 12b), at least five gear wheel planes (Z1a-Z5a; Z1b-Z5b) which each comprise a fixed gear wheel (Z11a-Z51a; Z11b-Z51b) permanently connected in a rotationally fixed manner to one of the input shafts (11a, 12a; 11b, 12b), wherein one of the gear wheel planes (Z4a; Z4b) comprises an idler gear wheel (Z42a; Z42b) arranged coaxially relative to the first countershaft (13a; 13b) and an idler gear wheel (Z43a; Z43b) arranged coaxially relative to the second countershaft (14a; 14b), which form a gear wheel pair for shifting into at least one reverse transmission gear (R1a, R2a), at least nine shift units (S1a-S9a; S1b-S9b) for producing an operative connection between the input shafts (11a, 12a; 11b, 12b) and/or the countershafts (13a, 14a; 13b, 14b), which in connection with the gear wheel planes (Z1a-Z5a; Z1b-Z5b) are provided at least constructively for shifting of at least eight sequentially shiftable forward transmission gears (V1a-V8a) and the at least one reverse transmission gear (R1a, R2a), an output (Z01a; Z01b) permanently connected in a rotationally fixed manner to the first countershaft (13a; 13b), and an output gear wheel (Z02a; Z02b) permanently connected, in a rotationally fixed manner, to the second countershaft (14a; 14b).

2. The dual clutch transmission according to claim 1, characterized in that the first gear wheel plane (Z1a; Z1b) comprises one of the fixed gears (Z11a; Z11b) permanently connected to the first input shaft (11a; 11b), a first idler gear (Z12a; Z12b) which is arranged coaxially relative to the first countershaft (13a; 13b) and which together with the fixed gear (Z11a; Z11b) of the first gear wheel plane (Z1a; Z1b) forms a gear wheel pair for shifting at least the eighth forward transmission gear (V8a), and a second idler gear (Z13a; Z13b) which is arranged coaxially relative to the second countershaft (14a; 14b) and which together with the fixed gear (Z11a; Z11b) of the first gear wheel plane (Z1a; Z1b) forms a gear wheel pair for shifting of at least the sixth forward transmission gear (V6a), wherein one of the shift units (S1a; S1b) is provided in order to connect the first idler gear (Z12a; Z12b) of the first gear wheel plane (Z1a; Z1b) and the first countershaft (13a; 13b) to one another in a rotationally fixed manner, and one of the shift units (S5a; S5b) is provided in order to connect the second idler gear (Z13a; Z13b) of the first gear wheel plane (Z1a; Z1b) and the second countershaft (14a; 14b) to one another in a rotationally fixed manner.

3. The dual clutch transmission according to claim 1 or 2, characterized in that the second gear wheel plane (Z2a; Z2b) comprises one of the fixed gears (Z21a; Z21b) permanently connected to the first input shaft (11a; 11b) in a rotationally fixed manner and an idler gear (Z22a; Z22b) arranged coaxially relative to the first countershaft (13a; 13b), which form a gear wheel pair for shifting of at least the fourth forward transmission gear (V4a), wherein one of the shift units (S2a; S2b) is provided in order to connect the idler gear (Z22a; Z22b) of the second gear wheel plane (Z2a; Z2b) and the first countershaft (13a; 13b) to one another in a rotationally fixed manner.

4. The dual clutch transmission according to one of the preceding claims, characterized in that the third gear wheel plane (Z3a, Z3b) comprises one of the fixed gears (Z31a; Z31b) permanently connected to the first input shaft (11a; 11b) in a rotationally fixed manner and an idler gear (Z33a; Z33b) arranged coaxially relative to the second countershaft (14a; 14b), which form a gear wheel pair for shifting of at least the second forward gear (V2a), wherein one of the shift units (S6a; S6b) is provided in order to connect the idler gear (Z33a; Z33b) of the third gear wheel plane (Z3a; Z3b) and the second countershaft (14a; 14b) to one another in a rotationally fixed manner.

5. The dual clutch transmission according to one of the preceding claims, characterized in that the fourth gear wheel plane (Z4a; Z4b) comprises one of the fixed gears (Z41a; Z41b) permanently connected to the second input shaft (12a; 12b) in a rotationally fixed manner and the gear wheel pair for shifting of the at least one reverse transmission gear (R1a; R2a), wherein the first idler gear (Z42a; Z42b), arranged coaxially relative to the first countershaft (13a; 13b), of the fourth gear wheel plane (Z4a; Z4b) and the fixed gear (Z41a; Z41b) of the fourth gear wheel plane (Z4a; Z4b) form a gear wheel pair for shifting of at least the third forward transmission gear (V3a).

6. The dual clutch transmission according to one of the preceding claims, characterized in that one of the shift units (S3a; S3b) is provided in order to connect the first idler gear (Z42a; Z42b) of the fourth gear wheel plane (Z4a; Z4b) and the first countershaft (13a; 13b) to one another in a rotationally fixed manner, and one of the shift units (S7a; S7b) is provided in order to connect the second idler gear (Z43a; Z43b) of the fourth gear wheel plane (Z4a; Z4b) and the second countershaft (14a; 14b) to one another in a rotationally fixed manner.

7. The dual clutch transmission according to claim 5 or 6, characterized in that the first idler gear (Z42b) of the fourth gear wheel plane (Z4b) comprises a dual toothing, wherein the fixed gear (Z41b) of the fourth gear wheel plane (Z4b) and the second idler gear (Z43b) of the fourth gear wheel plane (Z4b) are offset axially relative to one another and are permanently connected so as to mesh with the first idler gear (Z42b) of the fourth gear wheel plane (Z4b).

8. The dual clutch transmission at least according to claims 3 and 5, characterized in that one of the shift units (S9a; S9b) is provided in order to connect the first idler gear (Z42a; Z42b) of the fourth gear wheel plane (Z4a; Z4b) and the idler gear (Z22a; Z22b) of the second gear wheel plane (Z2a; Z2b) directly to one another in a rotationally fixed manner.

9. The dual clutch transmission according to one of the preceding claims, characterized in that the first gear wheel plane (Z5a; Z5b) comprises one of the fixed gears (Z51a; Z51b) permanently connected to the second input shaft (12a; 12b), a first idler gear (Z52a; Z52b) which is arranged coaxially relative to the first countershaft (13a; 13b) and which together with the fixed gear (Z51a; Z51b) of the fifth gear wheel plane (Z5a; Z5b) forms a gear wheel pair for shifting of at least the seventh forward transmission gear (V7a), and a second idler gear (Z13a; Z13b) which is arranged coaxially relative to the second countershaft (14a; 14b) and which together with the fixed gear (Z51a; Z51b) of the fifth gear wheel plane (Z5a; Z5b) forms a gear wheel pair for shifting of at least the fifth forward transmission gear (V5a), wherein one of the shift units (S4a; S4b) is provided in order to connect the fifth idler gear (Z52a; Z52b) of the first gear wheel plane (Z5a; Z5b) and the first countershaft (13a; 13b) to one another in a rotationally fixed manner, and one of the shift units (S8a; S8b) is provided in order to connect the second idler gear (Z53a; Z53b) of the fifth gear wheel plane (Z5a; Z5b) and the second countershaft (14a; 14b) to one another in a rotationally fixed manner.

10. The dual clutch transmission at least according to claims 3 and 5, characterized in that the first idler gear (Z42a; Z42b) of the fourth gear wheel plane (Z4a; Z4b) and the idler gear (Z22a; Z22b) of the second gear wheel plane (Z2a; Z2b) are provided in order to form a winding stage for shifting of at least the first forward transmission gear (V1a).

11. The dual clutch transmission according to one of the preceding claims, characterized by a ninth forward transmission gear (V9a) which can be shifted by at least one winding stage.

12. The dual clutch transmission comprising two input shafts (11c, 12c; 11d, 12d; 11e, 12e) which are provided for respectively linking to a power shift clutch (K1c, K2c; K1d, K2d; K1e, K2e), a first countershaft (13c; 13d; 13e) arranged offset parallel to the input shafts (11c, 12c; 11d, 12d; 11e, 12e), a second countershaft (14c; 14d; 14e) arranged offset parallel to the input shafts (11c, 12c; 11d, 12d; 11e, 12e), at least five gear wheel planes (Z1c-Z5c; Z1d-Z5d; Z1e-Z5e) which each comprise a fixed gear wheel (Z11c-Z51c; Z11d-Z51d; Z11e-Z51e) permanently connected in a rotationally fixed manner to one of the input shafts (11c, 12c; 11d, 12d; 11e, 12e), wherein one of the gear wheel planes (Z4c; Z4d; Z4e) comprises an idler gear (Z42c; Z42d; Z43e) arranged coaxially relative to one of the countershafts (13c; 13d; 14e) and an idler gear (Z43c; Z43d; Z42e) arranged coaxially relative to the other countershaft (14c; 14d; 13e), which form a gear wheel pair for shifting into at least one reverse transmission gear (R1c, R2c; R1d, R2d; R1e, R2e), an output gear (Z01c; Z01d; Z01e) arranged coaxially relative to the first countershaft (13c; 13d; 13e), an output gear (Z02c; Z02d; Z02e) permanently connected in a rotationally fixed manner to the second countershaft (14c; 14d; 14e), at least eight shift units (S1c-S8c; S1d-S8d; S1e-S8e) for producing operative connections between the input shafts (11c, 12c; 11d, 12d; 11e, 12e) and/or the countershafts (13c, 14c; 13d, 14d; 13e, 14e) and at least one shift unit (S9c; S9d; S9e) for producing an operative connection between the output gear (Z01c; Z01d; Z01e) arranged coaxially relative to the first countershaft (13c; 13d; 13e) and the first countershaft (13c; 13d; 13e), wherein in connection with the gear wheel planes (Z1c-Z5c; Z1d-Z5d; Z1e-Z5e) the at least nine shift units (S1c-S9c; S1d-S9d; S1e-S9e) are provided at least constructively for shifting of the at least eight sequentially shiftable forward transmission gears (V1c-V8c; V1d-V8d; V1e-V8e) and the at least one reverse transmission gear (R1c, R2c; R1d, R2d; R1e, R2e).
